(19) United States
(12) Patent Application Publication
(10) Pub. No.: US 2020/0116078 A1
(43) Pub. Date: Apr. 16, 2020

(54) DIFFERENTIAL VALVE TIMING WITH TWIN-SCROLL TURBINES

(71) Applicant: GM GLOBAL TECHNOLOGY OPERATIONS LLC, Detroit, MI (US)

(72) Inventors: Maqsood Rizwan Ali Khan, Rochester Hills, MI (US); Mark R. Claywell, Birmingham, MI (US)

(21) Appl. No.: 16/157,770

(22) Filed: Oct. 11, 2018

(51) Int. Cl. F02B 37/02; F01L 1/08

(52) U.S. Cl. CPC F02B 37/025; F01L 1/08

(57) ABSTRACT

An internal combustion engine is configured to periodically open and close combustion chamber exhaust valves of the engine such that one exhaust valve is held open longer than another exhaust valve and/or one exhaust valve opens before another exhaust valve relative to top dead center. The resulting differential exhaust valve timing can at least partially compensate for different swallowing capacities of the scrolls of a twin-scroll turbine.

### INTRODUCTION

The field of technology generally relates to turbocharged internal combustion engines and, more particularly, to such engines equipped with a twin-scroll turbocharger.

Turbochargers can be used with internal combustion engines to improve engine performance and/or efficiency by recovering some of the otherwise wasted energy downstream of the combustion chambers. A turbine is positioned in the flow of engine exhaust gas and is coupled with a compressor positioned at the air intake of the engine. The flowing exhaust gases turn the turbine and, in turn, the compressor, which increases air intake pressure and the fuel-burning capacity of the engine. In a twin-scroll turbocharger, exhaust gases from different cylinders of a multi-cylinder engine reach the impeller of the turbine via two separate flow channels. For a variety of reasons, these flow channels do not have identical swallowing capacities—i.e., one of the two channels has a greater capacity to flow gases through it than does the other. While this does not negate the benefits of a twin-scroll turbocharger relative to a single-scroll design, it results in an imbalance in certain gas flow characteristics between the separate flow channels and can cause a corresponding imbalance among the associated combustion chambers.

### SUMMARY

According to one embodiment, an internal combustion engine includes a first combustion chamber, a second combustion chamber, a turbocharger, a first exhaust valve, and a second exhaust valve. The turbo charger includes a first scroll and a second scroll having a swallowing capacity different from the first scroll. The first exhaust valve is configured to open and close according to a first periodic cycle and to allow combustion gases to pass from the first combustion chamber to the first scroll when open. The second exhaust valve is configured to open and close according to a second periodic cycle and to allow combustion gases to pass from the second combustion chamber to the second scroll when open. The first periodic cycle is different from the second periodic cycle to at least partially compensate for the different swallowing capacities of the first and second scrolls.

In some embodiments, the first scroll has a larger swallowing capacity than the second scroll, and the second periodic cycle includes a valve-open period that is longer than a valve-open period of the first periodic cycle.

In some embodiments, the valve-open period of the second periodic cycle is 5 or more crankshaft degrees longer than the valve-open period of the first periodic cycle.

In some embodiments, the first scroll has a larger swallowing capacity than the second scroll and the second periodic cycle includes a valve-open period that begins before a valve-open period of the first periodic cycle relative to a top dead center condition for each of the combustion chambers.

In some embodiments, the valve-open period of the second periodic cycle begins 5 or more crankshaft degrees before the valve-open period of the first periodic cycle.

In some embodiments, the second periodic cycle includes a valve-open period that begins before a valve-open period of the first periodic cycle relative to a top dead center condition for each of the combustion chambers, and the valve-open period of the second periodic cycle is longer than the valve-open period of the first periodic cycle.

In some embodiments, the engine includes a first cam lobe that rotates to define the first periodic cycle and a second cam lobe that rotates to define the second periodic cycle.

In some embodiments, the first scroll has a larger swallowing capacity than the second scroll and the cam lobes are shaped such that the second exhaust valve is open longer than the first exhaust valve.

In some embodiments, the first scroll has a larger swallowing capacity than the second scroll and the cam lobes are shaped such that the second exhaust valve opens before the first exhaust valve relative to a top dead center condition for each of the combustion chambers.

In some embodiments, the cam lobes are shaped such that the second exhaust valve opens before the first exhaust valve relative to a top dead center condition for each of the combustion chambers, and the cam lobes are shaped such that the second exhaust valve is open longer than the first exhaust valve.

According to another embodiment, an internal combustion engine includes a cam shaft configured to periodically open and close combustion chamber exhaust valves of the engine such that one exhaust valve is held open longer than another exhaust valve and/or one exhaust valve opens before another exhaust valve relative to respective combustion chamber top dead center conditions.

In some embodiments, the exhaust valve that is held open longer than and/or opens before the other exhaust valve controls flow of combustion gases to the smaller of two scrolls of a twin-scroll turbocharger.

In some embodiments, the engine further includes a first combustion chamber, a second combustion chamber, a first exhaust valve, and a second exhaust valve. The first exhaust valve is configured to open and close according to a first periodic cycle and to allow combustion gases to pass from the first combustion chamber to a first scroll of a twin-scroll turbocharger when open. The second exhaust valve is configured to open and close according to a second periodic cycle and to allow combustion gases to pass from the second combustion chamber to a second scroll of the twin-scroll turbocharger when open. The first scroll of the turbocharger has a swallowing capacity that is larger than a swallowing capacity of the second scroll of the turbo charger. The cam shaft includes a first cam lobe that rotates to define the first periodic cycle and a second cam lobe that rotates to define the second periodic cycle. Each periodic cycle includes a valve-open period having a duration and a beginning relative to a top dead center condition of the respective combustion chamber. One or both of the following conditions is satisfied:
(a) the duration of the valve-open period of the second periodic cycle is longer than the duration of the valve-open period of the first periodic cycle so that the second exhaust valve is held open longer that the first exhaust valve;
(b) the beginning of the valve-open period of the second periodic cycle is before the beginning of the valve-open period of the first periodic cycle so that the second exhaust valve opens before the first exhaust valve relative to the respective top dead center conditions,

whereby the engine includes differential exhaust valve timing to at least partially compensate for the different swallowing capacities of the first and second scrolls of the turbocharger.

It is contemplated that any of the features listed above, illustrated in the drawings, and/or described below can be combined with any one or more of the other features except where there is an incompatibility of features.

### BRIEF DESCRIPTION OF THE DRAWINGS

Illustrative embodiments will hereinafter be described in conjunction with the appended drawings, wherein like designations denote like elements, and wherein:

FIG. 1 is a schematic illustration of a portion of an internal combustion engine according to an exemplary embodiment;

FIG. 2 is a turbine map for a twin-scroll turbine illustrating the difference in swallowing capacity between the two scrolls;

FIG. 3 represents an example of differential valve timing in which one exhaust valve opens sooner and is open longer than another exhaust valve;

FIG. 4 represents an example of differential valve timing in which one exhaust valve opens sooner than another exhaust valve;

FIG. 5 represents an example of differential valve timing in which one exhaust valve is open longer than another exhaust valve;

FIG. 6 is a chart illustrating the predicted amount of imbalance of a propensity to knock among multiple engine cylinders with and without differential exhaust valve timing:

FIG. 7 is a chart illustrating the predicted amount of imbalance of the air-fuel ratio among multiple engine cylinders with and without differential exhaust valve timing:

FIG. 8 is a chart illustrating the predicted amount of imbalance of the net mean effective pressure among multiple engine cylinders with and without differential exhaust valve timing; and

FIG. 9 is a chart illustrating the predicted amount of imbalance of the pumping mean effective pressure among multiple engine cylinders with and without differential exhaust valve timing.

### DETAILED DESCRIPTION

As described herein, differential exhaust valve timing can be implemented to at least partially compensate for the imbalanced gas flow through an internal combustion engine that can result when the engine is equipped with a twin-scroll turbocharger. Due to a variety of differences between the separate exhaust flow paths through the turbine of a twin-scroll turbocharger (e.g., flow length, area, shape, direction and location of impingement on turbine impeller, shape of engine exhaust manifold, etc.), it is nearly impossible to design the two turbine scrolls to have identical gas flow characteristics in a practically sized package. Stated differently, a twin-scroll turbocharger places a different amount of back pressure on different cylinders of the engine.

An engine equipped with differential valve timing operates with valve opening time, valve closing time, valve open duration, and/or valve lift being different among different cylinders of the engine. This is distinguished from variable valve timing in which one or more valve timing parameters vary with engine speed for all of the cylinders. Differential valve timing can be implemented independently from engine speed such that the valve timing of one cylinder is different from that of another cylinder at all engine speeds. Both differential valve timing and variable valve timing may also be used together in the same engine.

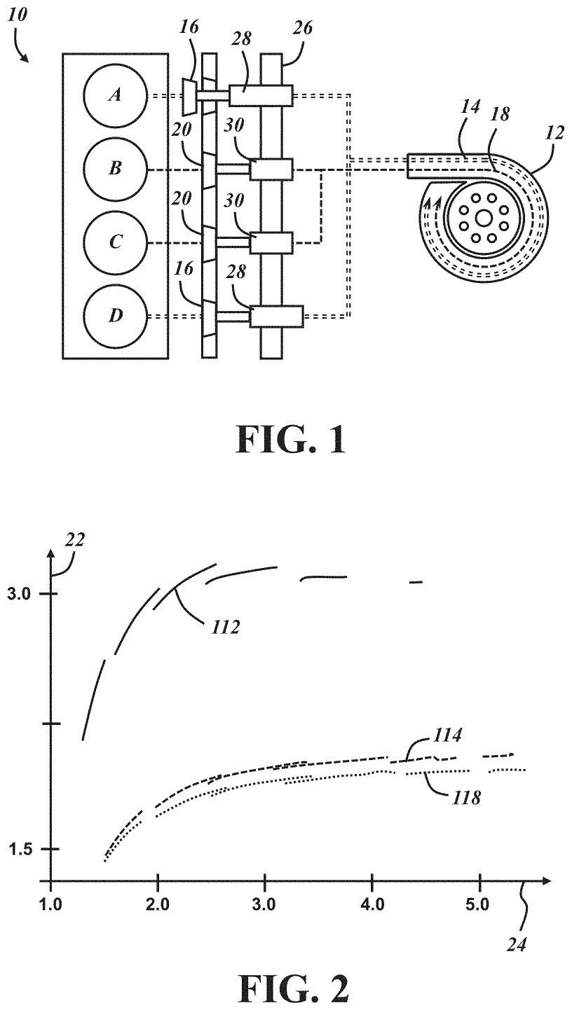

FIG. 1 schematically illustrates an example of an internal combustion engine 10 in which differential valve timing can be implemented to at least partly compensate for gas flow imbalance resulting from connection with a turbocharger having a twin-scroll turbine 12. For the sake of simplicity, only the turbine 12 of the turbocharger is illustrated. The compressor of the turbocharger and other engine components associated with the air intake side of the engine (e.g., intake valves) and the fuel delivery system are omitted.

The illustrated engine 10 is a four-cylinder engine with four combustion chambers A-D. Combustion chambers A and D are intermittently fluidly connected with a first scroll 14 of the turbine 12 via a pair of first exhaust valves 16, which open and close according to a first periodic cycle to allow combustion gases to pass from the associated combustion chambers to the first scroll when open. Combustion chambers B and C are intermittently fluidly connected with a second scroll 18 of the turbine 12 via a pair of second exhaust valves 20, which open and close according to a second periodic cycle to allow combustion gases to pass from the associated combustion chambers to the second scroll when open. The first scroll 14 and the second scroll 18 have different swallowing capacities, and the first and second periodic cycles of the respective exhaust valves 16, 20 are different from each other to at least partially compensate for the different swallowing capacities of the scrolls.

As used herein, swallowing capacity is a term of art that refers to the amount of gas a turbine scroll is capable of allowing to pass through the scroll per unit time. While there are no specific units associated with the swallowing capacity, it is most closely associated with mass flow rate, normalized by other gas flow variables such as temperature and density, and is used in a relative sense to compare flow capabilities of different flow channels. As such, one of the scrolls 14, 18 may be referred to as the large scroll, and the other may be referred to as the small scroll.

FIG. 2 is a turbine map for the turbine of a twin-scroll turbocharger, which is generated without the turbine attached to an engine. The turbine flow parameter (or normalized mass flow rate) 22 is plotted as a function of turbine expansion ratio 24. The composite curve 112 represented in solid lines was generated with gas flow permitted through both scrolls of the turbine 12. The other two composite curves 114, 118 were generated with gas flowing through only one of the two scrolls. The dashed composite curve 114 represents gas flow through only the first scroll 14, and the dotted composite curve 118 represents gas flow through only the second scroll 18. In this example, the first scroll 114 has a larger swallowing capacity than the second scroll 118. For example, at an expansion ratio of 3.0, the ratio of the flow parameter of the first scroll to the flow parameter of the second scroll is about 1.04. This ratio of flow parameters is even higher (about 1.045) at higher expansion ratios. In other words, with all other variables being equal, the first scroll 14 can accommodate over 4% more gas flow than the second scroll 18. Other twin-scroll turbines have been mapped to indicate a 3-5% higher flow parameter through the large scroll than through the small scroll.

Referring again to FIG. 1, the engine 10 may operate on a four-stroke cycle (i.e., intake, compression, combustion, and exhaust) and have an exemplary firing order of A-C-D-B. In the illustrated example, the engine 10 includes a cam shaft 26 that rotates to define the valve timing. The cam shaft 26 includes a pair of first cam lobes 28 that rotate to define the first periodic cycle for the first exhaust valves 16 and a pair of second cam lobes 30 that rotate to define the different second periodic cycle for the second exhaust valves 20. In a four-stroke engine, the cam shaft 26 rotates once for every two rotations of the engine crankshaft, and a piston cyclically moves back and forth along each combustion chamber between a top dead center (TDC) position and a bottom dead center (BDC) position with each rotation of the crankshaft. Each combustion chamber A-D thus experiences a top dead center condition and a bottom dead center condition twice during each rotation of the cam shaft 26. Each piston is at TDC at the end of the compression stroke and at the end of the exhaust stroke, and each piston is at BDC at the end of the intake stroke and at the end of the combustion stroke.

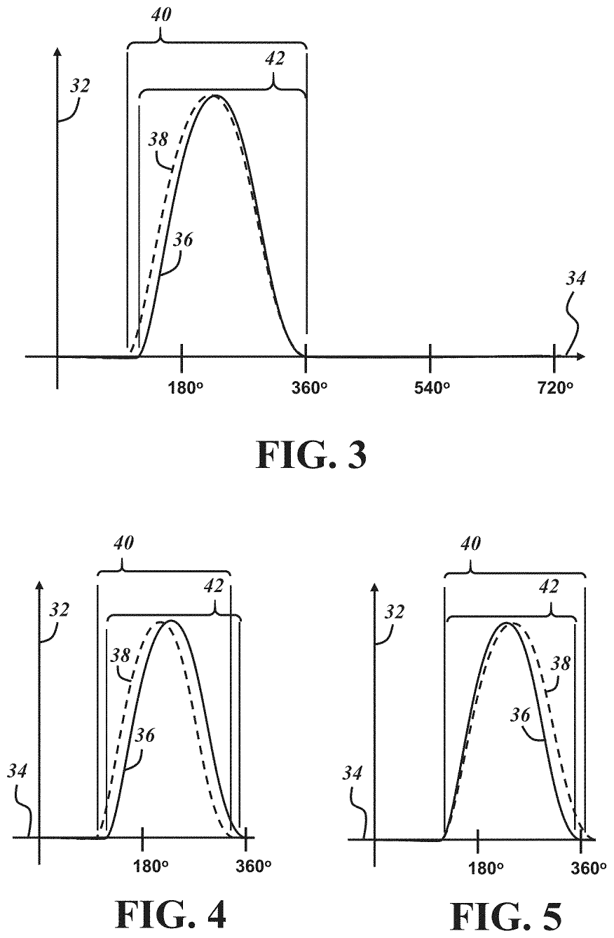

FIG. 3 is a chart illustrating exemplary differential exhaust valve timing through one rotation of the cam shaft 26 and two rotations of the crankshaft. The chart illustrates valve lift 32 of the first and second exhaust valves 16, 20 plotted as a function of crankshaft angle 34, representing the first and second periodic cycles 36, 38 of the exhaust valves. Valve lift 32 is in generic units of distance, and crankshaft angle is in degrees from TDC at the end of the compression stroke. The first periodic cycle 36 is plotted as a solid line and is associated with the first valves 16, combustion chambers A and D, and the first cam lobes 28. The second periodic cycle 38 is plotted as a dashed line and is associated with the second valves 20, combustion chambers B and C, and the second cam lobes 30.

In order to at least partially compensate for the different swallowing capacities of the first and second scrolls 14, 18 of the turbine 12, the first and second periodic cycles 36, 38 are different from each other. In this particular example, the second periodic cycle 38 has a valve-open period 40 that is longer than a valve-open period 42 of the first periodic cycle 36. Additionally, the valve-open period 40 of the second periodic cycle 38 begins before the valve-open period of the first periodic cycle 36. The valve-open periods may also be referred to as valve-open “durations” but are measured in degrees of crankshaft rotation rather than time to normalize for engine speed. Accordingly, with the exhaust valve timing illustrated in FIG. 3, the second exhaust valves 20 open sooner relative to TDC and stay open longer than the first exhaust valves 16 at a given engine speed. This example of differential valve timing helps compensate for different swallowing capacities where the first scroll 14 is the large scroll and the second scroll is the small scroll of the turbine 12.

Each valve-open period 40, 42 is the period between the crankshaft angle at which the respective valve opens (EVO) and the crankshaft angle at which the same valve closes (EVC). In the example of FIG. 3, the second valves 20 open about 10° crankshaft degrees in advance of the first valves 16, while both the first and second valves 16, 20 close at the same crankshaft angle. The valve-open duration 40 of the second valves 20 is therefore about 10° degrees greater than that of the first valves 16 in this example.

In some embodiments, the timing of the second exhaust valves 20 is advanced relative to the first exhaust valves 16 while the respective valve-open durations 40, 42 are the same. For example, the first cam lobes 28 and the second cam lobes 30 may have substantially identical cam profiles but be affixed to a central shaft of the cam shaft 26 such that the second valves 20 open sooner than the first valves 16 relative to TDC. This is illustrated in FIG. 4 in simplified form along the same axes as in FIG. 3. The curve representing the second periodic cycle 38 has the same shape as the first periodic cycle 36, but it is shifted toward a lower crankshaft angle (i.e. to the left) relative to the first periodic cycle.

In some embodiments, the second valves 20 open at the same EVO angle as the first valves 16 and have a greater valve-open duration 40 than do the first valves. This is illustrated in FIG. 5 in simplified form along the same axes as in FIGS. 3 and 4. The respective curves representing the first and second periodic cycles 36, 38 are the same shapes as in FIG. 3 with the second periodic cycle 38 shifted toward a higher crankshaft angle (i.e. to the right) than in FIG. 3.

In other examples, the valve-open period 40 of the second periodic cycle 38 is longer and begins relatively sooner than that of the first periodic cycle 36 without the respective EVC angles being the same. For instance, the second exhaust valves 20 may be advanced by 10° relative to the first exhaust valves 16 and close less than 10° before the first exhaust valves close. Or the second exhaust valves 20 may be advanced by 5° relative to the first exhaust valves 16 and close more than 5° after the first exhaust valves close. Various other combinations of EVO angles and valve-open durations are possible in which the valve-open period is longer and/or begins sooner for exhaust valves associated with the small turbine scroll than for exhaust valves associated with the large turbine scroll. In other variations, the amount of valve lift for exhaust valves associated with the small turbine scroll is greater than that of exhaust valves associated with the large turbine scroll. This can be combined with differential valve timing or employed independently to help compensate for the different swallowing capacities of the first and second turbine scrolls.

As used herein, relative terms such as greater, lesser, longer, shorter, sooner, later, etc. as used to describe the EVO angle, valve-open duration, and amount of valve lift are intended to refer to amounts that are beyond normal manufacturing tolerances. For example, where cam lobe manufacturing is performed with tolerances such that EVO angle varies by ±3° from nominal design intent, then the EVO angle of one valve is said to be lower than the EVO angle of another valve if it is more than 3 degrees lower. It is contemplated that manufacturing tolerances will decrease over time as manufacturing techniques are improved.

Differential valve timing employed in an internal combustion engine equipped with a twin-scroll turbocharger as disclosed above has now been computer-modeled in order to evaluate its effect on the gas flow imbalance caused by turbine scrolls having different swallowing capacities. It is noted that the differential exhaust valve timing described herein does not equalize or otherwise change the swallowing capacity of the turbine scrolls. Swallowing capacity is an intrinsic characteristic of the scrolls and is not considered alterable absent variable scroll geometry. But the different swallowing capacities of the two scrolls causes measurable differences in certain other engine operating parameters.

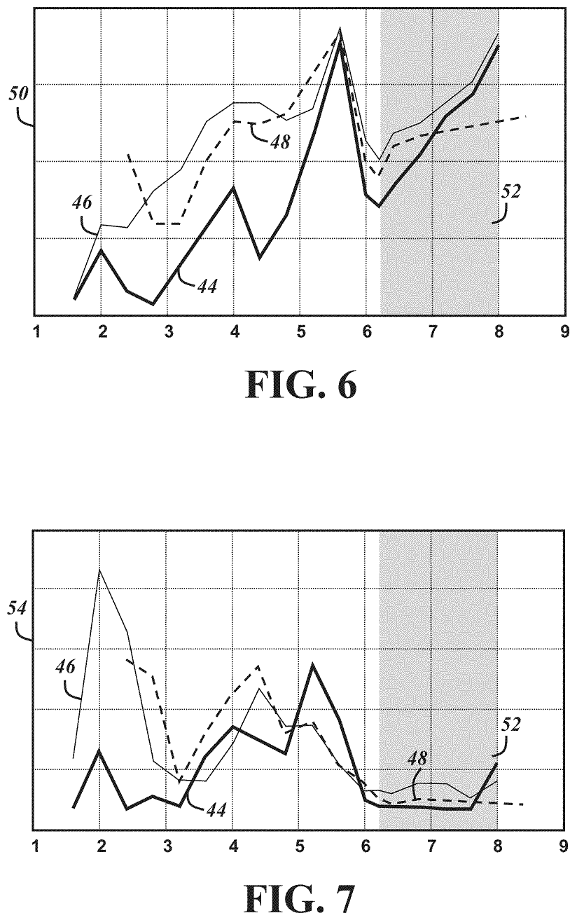

FIGS. 6-9 illustrate some examples of these differences via computer-modeling. The model is the same for all of FIGS. 6-9 and is based on a 4-cylinder engine equipped with a twin-scroll turbocharger, with exhaust valves for alternately firing cylinders routed to separate turbine scrolls—i.e., the first and third cylinders in the firing order are routed to one scroll, and the second and fourth cylinders in the firing order are routed to the other scroll. In each of FIGS. 6-9, the average absolute deviation from mean (AAD) among the four cylinders for a particular variable is plotted as a function of engine speed, which is given in thousands of revolutions per minute. The values and units for AAD are not given because it is used here for comparison purposes only. In all cases, a lower AAD is considered better because it generally represents an amount of imbalance among the various cylinders of the engine.

The heavy solid line in each of FIGS. 6-9 represents a theoretical condition 44 in which both scrolls of the twin-scroll turbine have identical swallowing capacities. The thin solid line in each of FIGS. 6-9 represents a biased condition 46 in which the two scrolls have different swallowing capacities and the exhaust valve timing is the same for all cylinders. The dashed line in each of FIGS. 6-9 represents a compensated condition 48 in which the two scrolls have different swallowing capacities and differential exhaust valve timing is employed in accordance with this disclosure.

FIG. 6 illustrates the AAD of the propensity 50 of the modeled cylinders to exhibit knocking during ignition. FIG. 6 generally indicates that the propensity to knock 50 varies the least among the cylinders in the theoretical equal scroll flow condition 44 and varies the most in the biased condition 46 without differential valve timing. Compensation for the bias via differential valve timing 48 shows a general improvement over the biased condition 46, particularly in the peak engine power range 52, which is between 6200 and 8000 rpm in this case.

FIG. 7 illustrates the AAD of the air-fuel ratio (AFR) 54 in the modeled cylinders. FIG. 7 indicates that which of the three modeled conditions exhibits the most or least variation among cylinders varies in the lower engine speed range; but in the peak engine power range 52, compensation via differential valve timing 48 shows a general improvement over the biased condition 46.

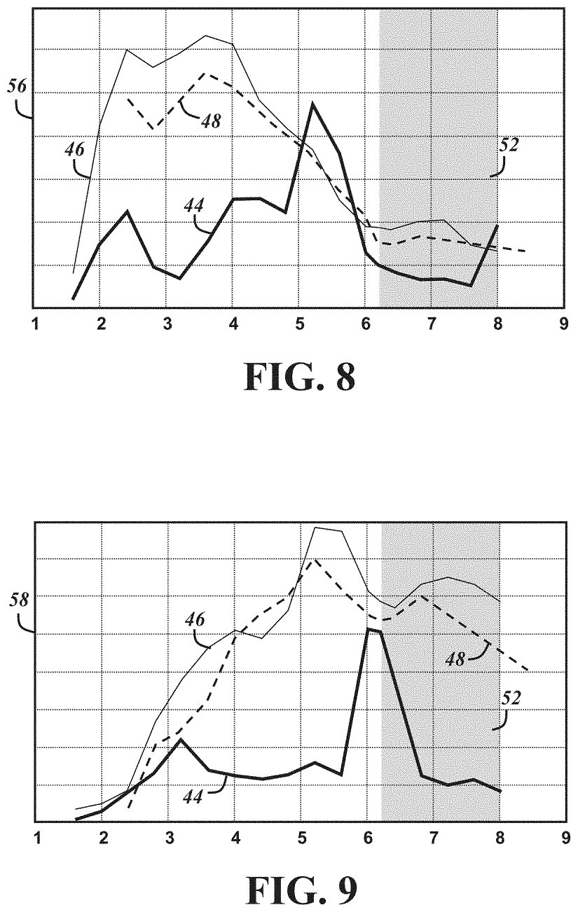

FIG. 8 illustrates the AAD of the net mean effective pressure (NMEP) 56 in the modeled cylinders. FIG. 8 generally indicates that the NMEP 56 varies the least among the cylinders in the theoretical equal scroll flow condition 44 and varies the most in the biased condition 46 without differential valve timing, at most engine speeds. Compensation for the bias via differential valve timing 48 shows a general improvement over the biased condition 46, particularly in the peak engine power range 52.

FIG. 9 illustrates the AAD of the pumping mean effective pressure (PMEP) 58 in the modeled cylinders. FIG. 9 generally indicates that the NMEP 56 varies the least among the cylinders in the theoretical equal scroll flow condition 44 and varies the most in the biased condition 46 without differential valve timing. Compensation for the bias via differential valve timing 48 shows a general improvement over the biased condition 46, particularly in the peak engine power range 52.

In the simulations used to generate FIGS. 6-9, the valve-open duration of the exhaust valves feeding the small scroll of the turbine was 4% greater than that of the exhaust valves feeding the large scroll, but improvements—i.e., decreases in variation among the cylinders—may be realized with smaller and larger valve-open duration differentials. In various embodiments, the valve-open duration of the exhaust valves feeding the small turbine scroll is greater than that of the valves feeding the large turbine scroll by a crankshaft angle in a range between 3 and 20 crankshaft degrees. In some embodiments, the valve-open duration differential is between 5 and 20 crankshaft degrees, or between 5 and 15 crankshaft degrees.

In embodiments where there is a valve-open duration differential among the exhaust valves, at least a portion of the additional duration of the longer duration may occur at a lower relative crankshaft angle, as in the example of FIG. 3, where all of the approximately 10° of additional second valve-open duration 40 occurs at the EVO end of the curve. In this manner, at least a portion of the longer valve-open duration is also manifested as a lower EVO angle.

In various embodiments, the exhaust valves feeding the small turbine scroll open at a relative crankshaft angle that is less than that of the valves feeding the large turbine scroll by an amount in a range between 3 and 20 crankshaft degrees. In some embodiments, the EVO angle differential is between 5 and 20 crankshaft degrees, or between 5 and 15 crankshaft degrees. In embodiments where there is an EVO angle differential among the exhaust valves, the valve-open duration of the earlier-opening valve may be at least as long as the valve-open duration of the later-opening valve.

While presented in the context of a four-cylinder, four-stroke engine with one twin-scroll turbocharger and with one exhaust valve per cylinder, it should be understood that the benefits of the disclosed differential valve timing may be realized with other types of combustion engines equipped with multi-scroll turbochargers. Variations include engines with any number of cylinders greater than one and any number of intake and/or exhaust valves per cylinder. Additionally, while the above description is presented using cam shafts to define the valve timing, it is contemplated that other valve timing systems, such as electric actuator-controlled systems, could be configured to operate with differential valve timing as described herein to reap the same benefits as cam-controlled valve timing.

It is to be understood that the foregoing description is not a definition of the invention but is a description of one or more exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

What is claimed is:

1. An internal combustion engine, comprising:
a first combustion chamber;
a second combustion chamber;
a turbocharger comprising a first scroll and a second scroll having a swallowing capacity different from the first scroll;
a first exhaust valve configured to open and close according to a first periodic cycle and to allow combustion gases to pass from the first combustion chamber to the first scroll when open; and
a second exhaust valve configured to open and close according to a second periodic cycle and to allow combustion gases to pass from the second combustion chamber to the second scroll when open,
wherein the first periodic cycle is different from the second periodic cycle to at least partially compensate for the different swallowing capacities of the first and second scrolls.

2. The internal combustion engine of claim 1, wherein the first scroll has a larger swallowing capacity than the second scroll and the second periodic cycle includes a valve-open period that is longer than a valve-open period of the first periodic cycle.

3. The internal combustion engine of claim 2, wherein the valve-open period of the second periodic cycle is 5 or more crankshaft degrees longer than the valve-open period of the first periodic cycle.

4. The internal combustion engine of claim 1, wherein the first scroll has a larger swallowing capacity than the second scroll and the second periodic cycle includes a valve-open period that begins before a valve-open period of the first periodic cycle relative to a top dead center condition for each of the combustion chambers.

5. The internal combustion engine of claim 4, wherein the valve-open period of the second periodic cycle begins 5 or more crankshaft degrees before the valve-open period of the first periodic cycle.

6. The internal combustion engine of claim 4, wherein the valve-open period of the second periodic cycle is longer than the valve-open period of the first periodic cycle.

7. The internal combustion engine of claim 1, further comprising a first cam lobe that rotates to define the first periodic cycle and a second cam lobe that rotates to define the second periodic cycle.

8. The internal combustion engine of claim 7, wherein the first scroll has a larger swallowing capacity than the second scroll and the cam lobes are shaped such that the second exhaust valve is open longer than the first exhaust valve.

9. The internal combustion engine of claim 8, wherein the valve-open period of the second periodic cycle is 5 or more crankshaft degrees longer than the valve-open period of the first periodic cycle

10. The internal combustion engine of claim 7, wherein the first scroll has a larger swallowing capacity than the second scroll and the cam lobes are shaped such that the second exhaust valve opens before the first exhaust valve relative to a top dead center condition for each of the combustion chambers.

11. The internal combustion engine of claim 10, wherein the valve-open period of the second periodic cycle begins 5 or more crankshaft degrees before the valve-open period of the first periodic cycle.

12. The internal combustion engine of claim 10, wherein the cam lobes are shaped such that the second exhaust valve is open longer than the first exhaust valve.

13. An internal combustion engine comprising a cam shaft configured to periodically open and close combustion chamber exhaust valves of the engine such that one exhaust valve is held open longer than another exhaust valve and/or one exhaust valve opens before another exhaust valve relative to respective combustion chamber top dead center conditions.

14. The internal combustion engine of claim 13, wherein the exhaust valve that is held open longer than and/or opens before the other exhaust valve controls flow of combustion gases to the smaller of two scrolls of a twin-scroll turbocharger.

15. The internal combustion engine of claim 13, further comprising:
a first combustion chamber;
a second combustion chamber:
a first exhaust valve configured to open and close according to a first periodic cycle and to allow combustion gases to pass from the first combustion chamber to a first scroll of a twin-scroll turbocharger when open; and
a second exhaust valve configured to open and close according to a second periodic cycle and to allow combustion gases to pass from the second combustion chamber to a second scroll of the twin-scroll turbocharger when open,
wherein the first scroll of the turbocharger has a swallowing capacity that is larger than a swallowing capacity of the second scroll of the turbo charger,
wherein the cam shaft includes a first cam lobe that rotates to define the first periodic cycle and a second cam lobe that rotates to define the second periodic cycle,
wherein each periodic cycle includes a valve-open period having a duration and a beginning relative to a top dead center condition of the respective combustion chamber, and
wherein one or both of the following conditions is satisfied:
(a) the duration of the valve-open period of the second periodic cycle is longer than the duration of the valve-open period of the first periodic cycle so that the second exhaust valve is held open longer that the first exhaust valve:
(b) the beginning of the valve-open period of the second periodic cycle is before the beginning of the valve-open period of the first periodic cycle so that the second exhaust valve opens before the first exhaust valve relative to the respective top dead center conditions,
whereby the engine includes differential exhaust valve timing to at least partially compensate for the different swallowing capacities of the first and second scrolls of the turbocharger.
